(19) United States
(12) Patent Application Publication
(10) Pub. No.: US 2004/0010973 A1
(43) Pub. Date: Jan. 22, 2004

(54) Automatic door sweep

(75) Inventors: Stefano Lio, Toronto (CA); Zoran Baic, Mississauga (CA); Terry Woodside, Toronto (CA); Leonoard Pate, Los Angeles, CA (US)

Correspondence Address: BERESKIN AND PARR, SCOTIA PLAZA, 40 KING STREET WEST-SUITE 4000 BOX 401, TORONTO, ON, M5H 3Y2, CA

(73) Assignee: TK Canada Limited, Toronto (CA)

(21) Appl. No.: 10/198,986

(22) Filed: Jul. 22, 2002

(51) Int. Cl. E06B 7/20

(52) U.S. Cl. 49/306

(57) ABSTRACT

An automatic sweep for a sliding door includes a seal member that is coupled to a housing at the bottom end of the door for movement between a raised position when the door is open and a lowered position when the door is closed, in which the seal member provides an acoustical seal for the gap that would otherwise exist at the bottom of the door. The sweep is actuated by an over-centre linkage that co-operates with an abutment adjacent the door opening. As the door reaches its closed position, the linkage is displaced from a normal extended configuration to an angled configuration, which laterally displaces an operating rod connected to a leaf-spring that then presses down on the seal member to move the member to its lowered position. When the door is opened, the over-centre linkage is moved back to its extended configuration, the rod is displaced in the opposite direction, and the leaf-spring raises the seal member.

### FIELD OF THE INVENTION

This invention relates generally to so-called automatic “door bottoms” or “sweeps” used to provide a seal between the bottom edge of a door and an underlying floor surface when the door is closed. For convenience, the term “sweep” is used herein.

### BACKGROUND OF THE INVENTION

A conventional automatic sweep comprises an elongate seal member (typically an aluminum extrusion) that carries a rubber sealing strip. The seal member is set into and extends along the bottom edge of the door so that it can move up and down between a raised position when the door is open and a lowered position when the door is closed. In the lowered position, the seal member provides an acoustical seal for the gap that would otherwise exist at the bottom of the door.

Movement of the seal member between its raised and lowered positions is accomplished by a mechanical linkage that responds to opening and closing of the door. Typically, the linkage is actuated by a pin that projects from an inner end of the sweep for contact with a fixed jamb adjacent the door opening. Generally, this type of sweep is suitable for a hinged door only. As the door pivots about its hinges towards a closed position, the pin is depressed by contact with the jamb, actuating the linkage and moving the sweep to its lowered position. The linkage is spring-biassed so that, as the door is opened, the pin returns to its projecting position, raising the sweep.

Generally, this type of automatic sweep is not suitable for a sliding door because there is no counterpart for the fixed jamb of a hinged door assembly for positively actuating the sweep. In some cases, a sliding pocket door may have a fixed abutment surface that could be used, but even then there may be a tendency for the door to “bounce” when it is closed, with the result that the sweep mechanism would not be positively actuated. Conventional hinged door sweeps are not suitable for so-called “barn door” types of sliding doors in which the door moves parallel to and is spaced outwardly from a wall surface containing the door opening.

An object of the present invention is to provide an automatic door sweep for a sliding door.

### SUMMARY OF THE INVENTION

The door sweep provided by the invention includes an elongate seal member adapted to be coupled to a bottom end of the door for movement between a raised position and a lowered position and means for moving the seal member between said raised and lowered positions. These means include an elongate operating element that extends generally parallel to and above the seal member and is longitudinally displaceable between first and second positions corresponding respectively to open and closed positions of the door. Coupling means is provided between the operating element and the seal member and is adapted to translate longitudinal displacement of the operating element into movement of the seal member between said raised and lowered positions. Actuator means project laterally of the sweep for co-operation with stationary abutment means adjacent an opening to be closed by the door in use. The actuator means and abutment means co-operate to cause movement of the operating element to its said second position as the door moves to its closed position, and to cause movement of the operating element to its said second position as the door moves to its closed position, and to cause movement of the operating element from its second position to its first position as the door is moved away from its closed position towards its open position.

Preferably, the operating element incorporates an over-centre linkage which is movable between an angled configuration corresponding to the “door closed” position of the sweep, and an extended configuration when the door is open. The provision of an over-centre linkage provides for positive “latching” of the seal member of the sweep in the raised or lowered position.

The coupling means between the operating element and the seal member preferably comprises a leaf-spring having a first end connected to the operating element and a second end which is fixed with respect to the element, in which the leaf-spring is arranged to exert downward pressure on the seal member as the operating element is displaced in response to the door reaching its closed position.

### BRIEF DESCRIPTION OF DRAWINGS

In order that the invention may be more clearly understood, reference will now be made to the accompanying drawings which illustrate a particular preferred embodiment of the invention by way of example, and in which:

FIG. 1 is a perspective view of a so-called “barn door” type of sliding door, showing the door in an open position;

FIG. 2 is a view similar to FIG. 1 showing the door closed;

FIGS. 3 and 4 are simplified plan views corresponding respectively to FIGS. 1 and 2;

FIG. 5 is an elevational view showing the bottom portion of the door and associated wall structure in the closed position of FIG. 2;

FIG. 6 is a partially exploded perspective view corresponding to FIG. 5 and showing the cross-sectional shape of a housing of the sweep; FIG. 7 is a partially exploded perspective view showing the principal components of the sweep in the open position of the door;

FIG. 8 is a view similar to FIG. 7 showing the components in the closed position of the door;

FIG. 9 is an end elevational view of the housing of the sweep seen in FIG. 6;

FIG. 10 is a partially exploded perspective view of an over-centre linkage that forms part of the sweep mechanism; and,

FIGS. 11 and 12 are plan views showing the over-centre linkage respectively in the positions of FIGS. 7 and 8.

### DESCRIPTION OF PREFERRED EMBODIMENT

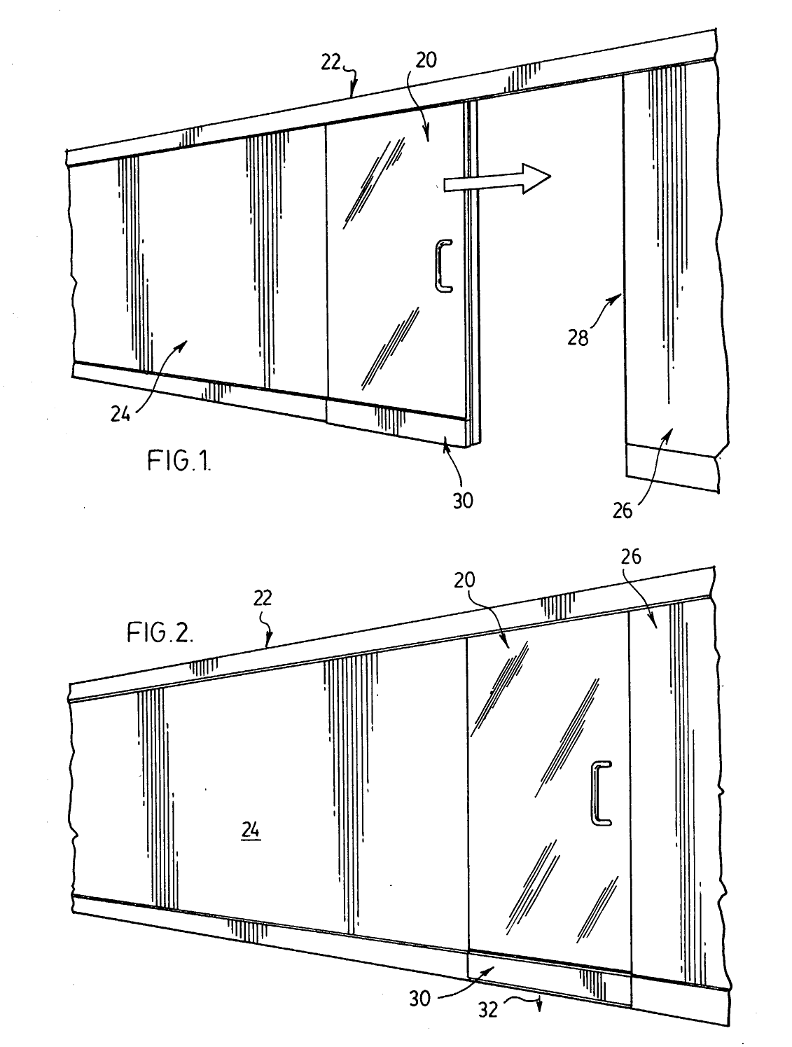

Referring to the drawings, FIGS. 1 and 2 show part of a wall structure that includes “barn door” type of sliding door, for example in an office partition system. The door itself is indicated by reference numeral 20 and is suspended from an overhead track 22 for movement parallel to and spaced slightly outwardly from fixed wall panels 24 and 26, between the open position in which it is shown in FIG. 1 and the closed position shown in FIG. 2. A door opening between the fixed wall panels 24 and 26 is indicated at 28 in FIG. 1. An automatic sweep at the bottom end of door 20 is generally indicated at 30 and includes a seal member (not visible in FIGS. 1 and 2) that is movable between a raised position when the door is open (FIG. 1) and a lowered position when the door is closed, as indicated by arrow 32 in FIG. 2. In the lowered position, the sweep provides an acoustical seal for the gap that would otherwise exist at the bottom of the door.

The track 22 and the associated mechanism by which the door is suspended from the track have not been shown since they form no part of the present invention. Barn door tracks and suspension systems are well-known in the art.

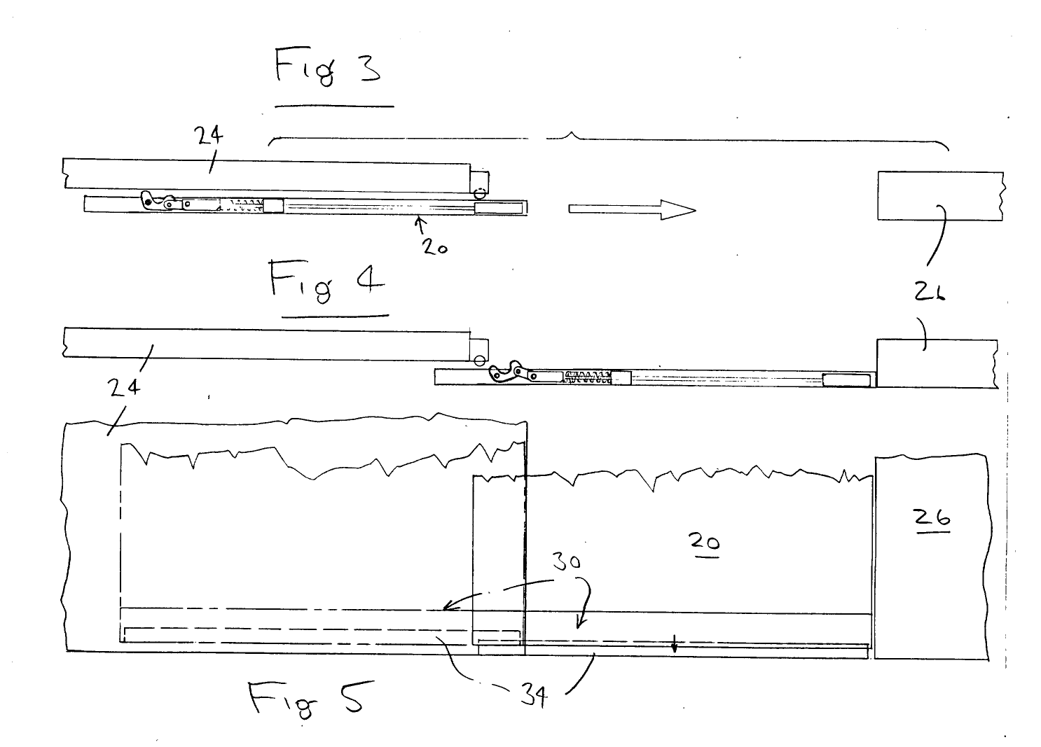

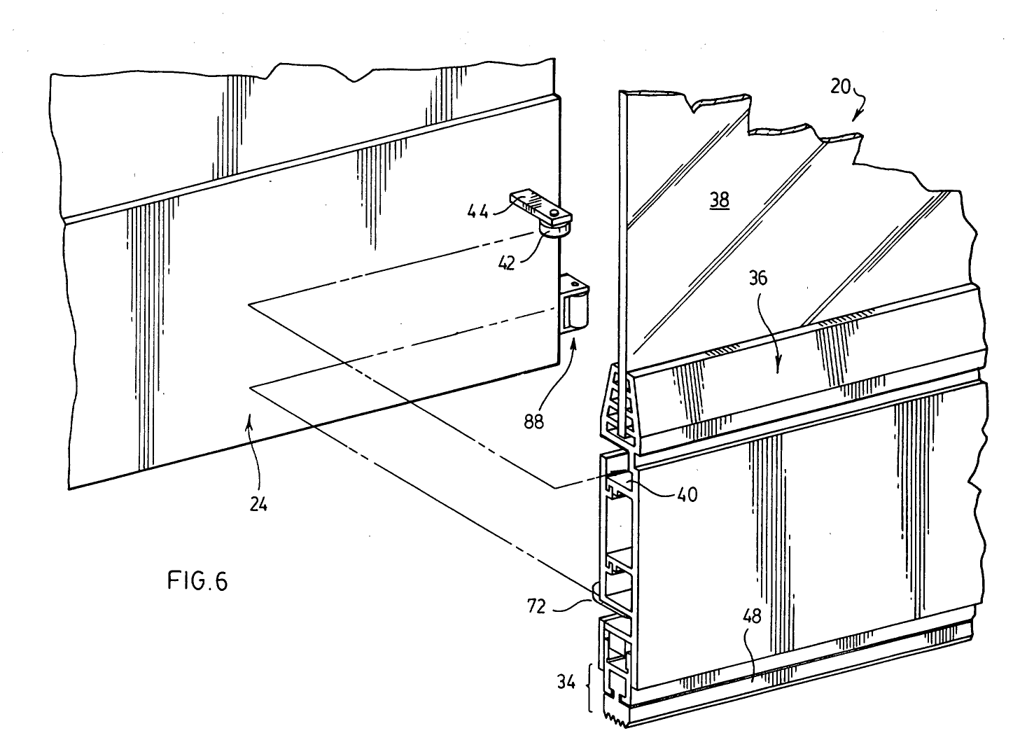

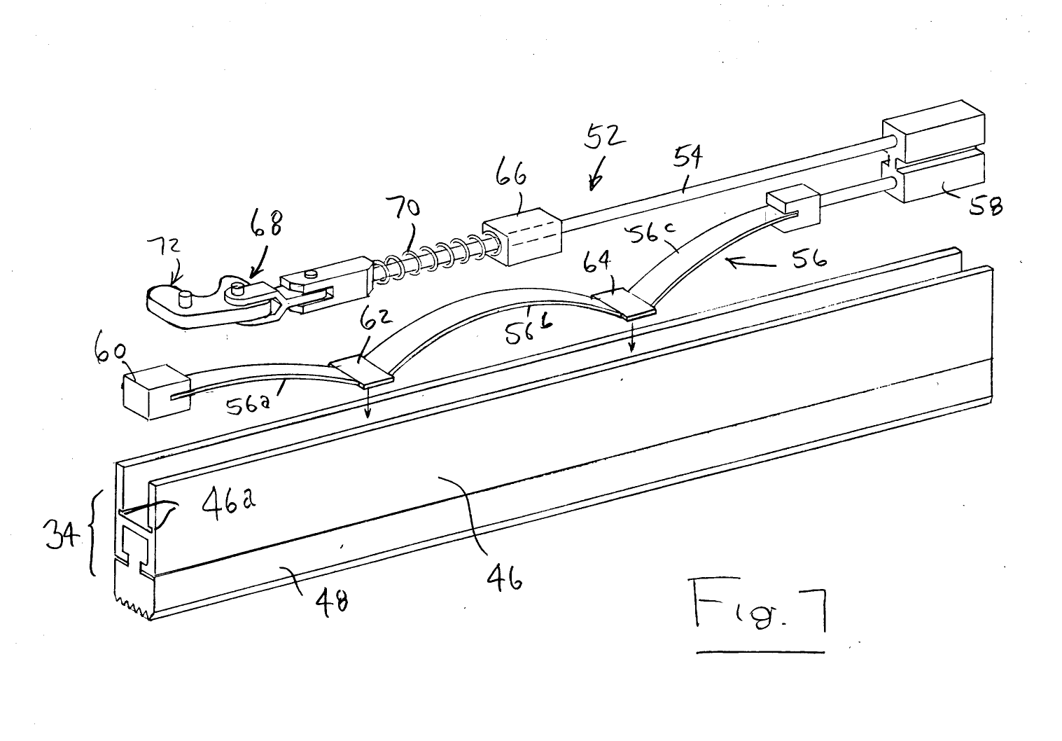

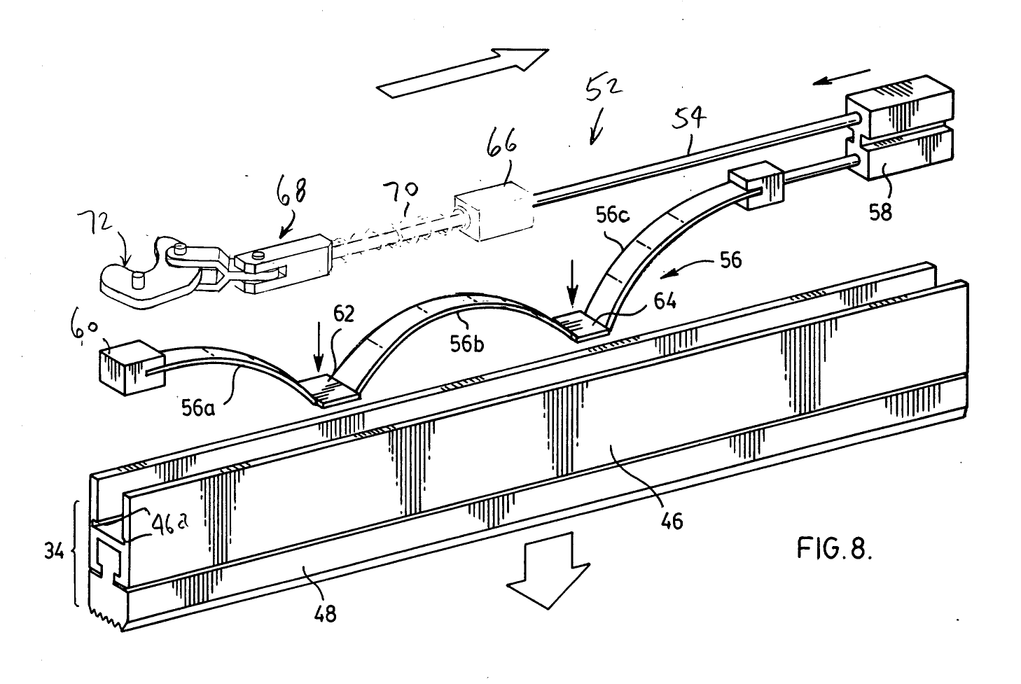

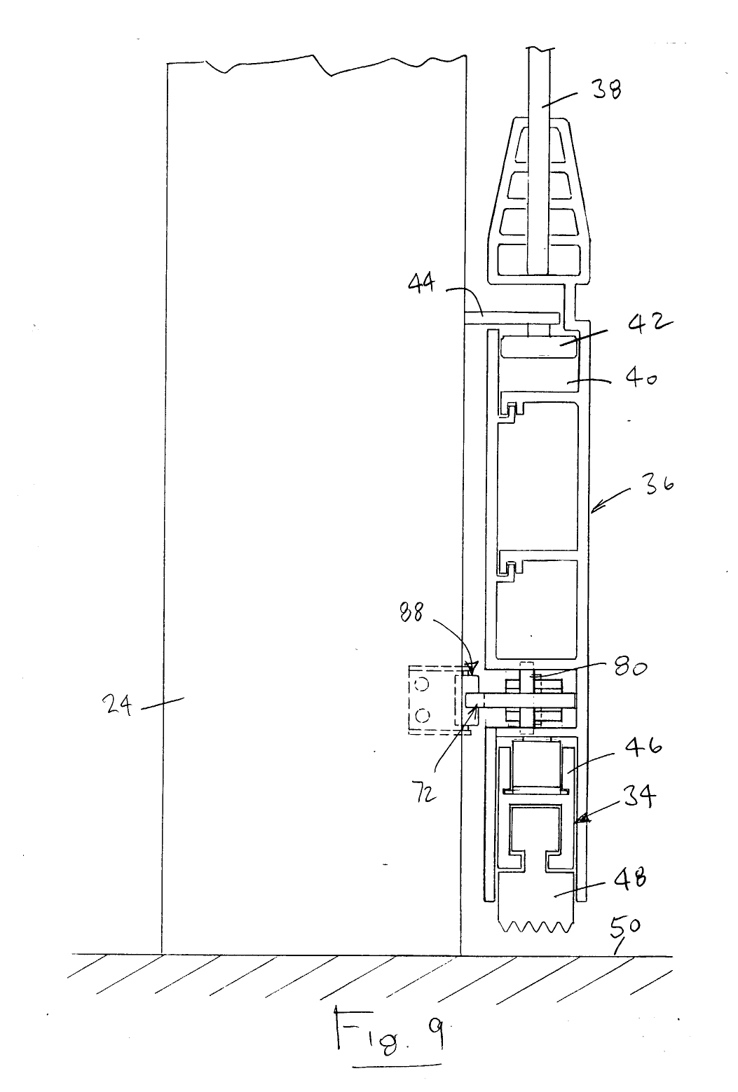

FIGS. 3 and 4 are plan views showing the door respectively in the open position of FIG. 1 and the closed position of FIG. 2. Some of the components of sweep mechanism have been indicated schematically in these views and are shown in more detail in other views. FIG. 5 shows door 20 in full lines in its closed position and in ghost outline in its open position. A seal member of the sweep is indicated at 34 and is shown in a lowered (sealing) position in full lines (door closed) and in a raised position in ghost outline (door open).

Sweep 30 includes a housing 36 that comprises an assembly of aluminum extrusions, and the cross-sectional shape of which can best be seen in FIGS. 6 and 9. A decorative end cap for housing 36 is not shown. The housing embraces the bottom marginal portion of a panel 38 of the door 20. As such, the sweep in effect forms a bottom end portion of the door; for this reason, a sweep is sometimes referred to a “door bottom”.

Housing 36 includes a track 40 that receives a guide roller 42 carried by an arm 44 that projects outwardly from the fixed wall structure of the office partition system. Arm 44 is dimensioned so that roller 42 maintains the sweep at a defined distance from the fixed wall structure, thereby holding the door parallel to the outer surface of the wall structure as the door moves between its open and closed positions.

FIG. 9 shows the cross-sectional shape of housing 36 in more detail, as well as the cross-sectional shape of the seal member 34. Member 34 comprises a housing 46 (also an aluminum extrusion), and a rubber sealing strip 48 that is carried by the housing so as to extend downwardly therefrom over substantially the entire width of the door. In FIG. 9, the seal member comprising house 46 and sealing strip 48 is in a raised position corresponding to the open position of the door (FIG. 2). The seal member is movable downwardly, as will be described, to a lowered position in which the sealing strip 48 makes contact with and seals against a floor surface 50 at the bottom of the door opening.

FIGS. 7 and 8 show the seal member in perspective. A mechanism for moving the seal member between its raised and lowered positions is generally indicated by reference numeral 52 and includes an elongate operating element (a rod) 54 that extends generally parallel to and above the seal member 34 and that is longitudinally displaceable between the two positions in which it is shown, respectively, in FIGS. 7 and 8. FIG. 7 corresponds to the open position of the door (seal member raised). Movement of rod 54 to the left in FIG. 7 causes the seal member to move downwardly corresponding to the closed position of the door (FIG. 2). The rod 54 is coupled to the seal member 34 by what is essentially a leaf-spring 56 that extends between a block 58 at one end of rod 54, which moves with the rod, and a fixed block 60, so that movement of block 58 to the left in FIG. 7 causes the leaf-spring 56 to press down on the seal member 34, moving the seal member to its lowered position. Leaf-spring 56 in fact comprises three arcuate segments 56a, 56b and 56c. The centre segment 56b meets the two end segments 56a and 56c at respective plates 62 and 64 that are received in slots 46a in housing 46 so that the plates are effectively coupled to the housing in the vertical direction. In other words, the plates are slid longitudinally into the slots 46a from one end of housing 46, and then are immovable with respect to the housing in the vertical direction.

Rod 54 extends leftward (as drawn) from block 58 through a fixed block 66 to an over-centre linkage 68 at the end of rod 54 opposite block 58. A helical compression spring 70 extends between the linkage and the fixed block 66.

The over-centre linkage 68 includes an outer link 72 which is generally C-shaped and is positioned to co-operate with a stationary abutment carried by the fixed wall structure of the office partition system. Link 72 is an actuator means for the over-centre linkage 68. As will be described in more detail later, co-action between the abutment and the link 72 causes the linkage 68 to move between the extended configuration in which it appears in FIG. 7 (in which the rod 54 is in its extreme right-hand position) and the angled over-centre configuration in which the linkage appears in FIG. 8, in which rod 54 has moved to the left, causing the leaf-spring 56 to depress the seal member 34.

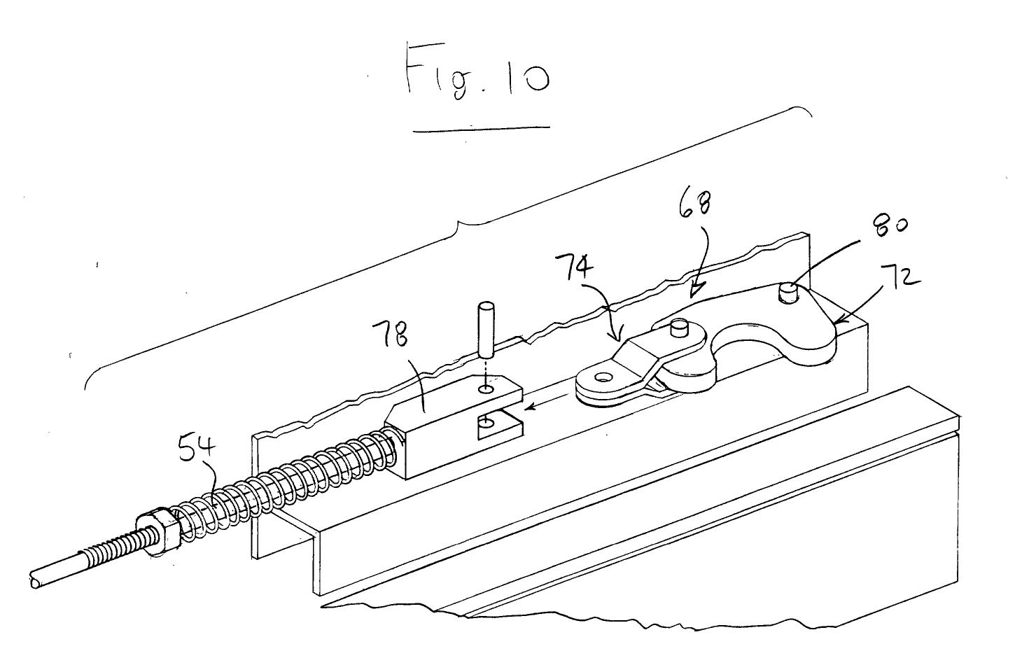

FIGS. 10, 11 and 12 show the over-centre linkage 68 in some detail. It can be seen from FIG. 10 that, in addition to link 72, the linkage includes an inner link 74 that is pivoted adjacent an outer end to an inner end portion of link 72, and adjacent an inner end to a fitment 78 on rod 54. Adjacent its outer end, link 72 is mounted to turn on a fixed pivot pin 80 carried by the housing 36 of the sweep (FIG. 9).

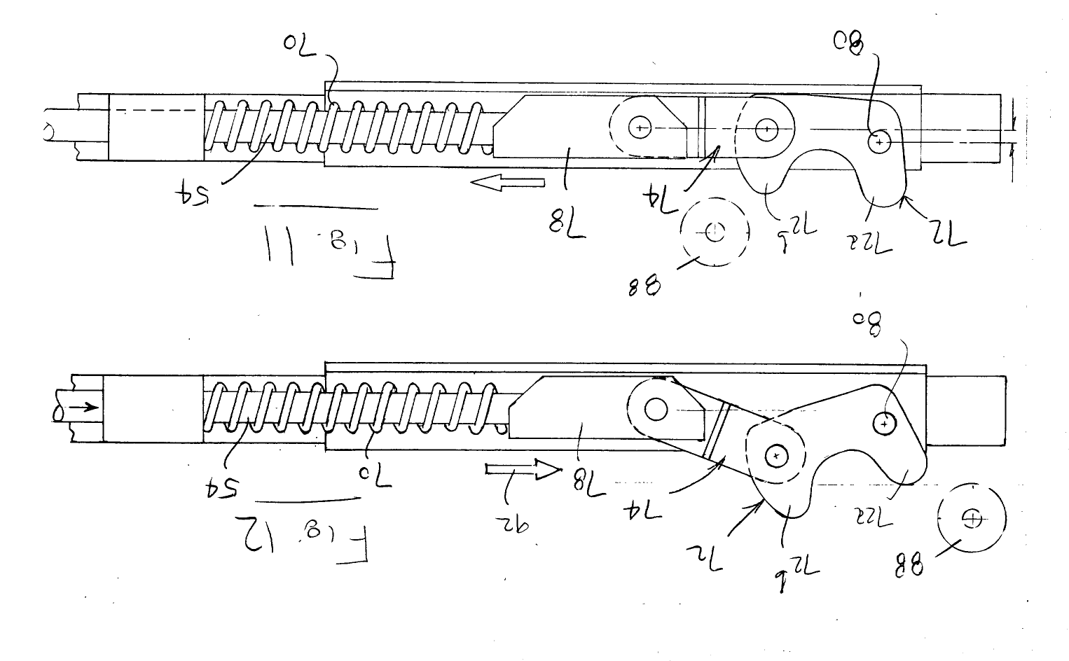

FIG. 11 shows the over-centre linkage in the position of FIG. 7, in which the linkage is extended and rod 54 is in its maximum right-hand position, as seen in FIG. 7. In this position, the leaf-spring 56 has been, in effect, flattened, raising the seal member 34 to its uppermost position.

FIG. 12, on the other hand, shows the linkage in the over-centre position in which the outer link 72 has turned on pivot pin 80 in the counterclockwise direction as seen in FIGS. 11 and 12, drawing rod 54 to the left in FIG. 7, and causing the leaf-spring 56 to press down on the seal member, moving the member to its lowered position, as shown in FIG. 8.

FIGS. 11 and 12 also show a roller 88, that provides the stationary abutment for operating the over-centre linkage 68. Roller 88 projects from wall panel 24 as best seen in FIG. 4 for contact by the outer link 72 of the over-centre linkage. As the door approaches the closed position (FIG. 11), roller 88 contacts the projecting outer end 72a of the link 72, rotating the link counter-clockwise about pin 80, causing the linkage to go over centre and move to the position shown in FIG. 12. This is the “door closed” position. Rod 54 has been moved to the left and the leaf-spring 56 has caused the seal member to move to its lowered, sealing position.

When the door is opened, in the direction of arrow 92 in FIG. 12, the roller 88 will contact the inner end 72b of link 72, after the door has moved a short distance, rotating link 72 clockwise, and returning the linkage to the position shown in FIG. 11. During this motion, rod 54 has been moved to the right, and the leaf-spring 56 has moved the seal member to the raised position (door open).

It will be understood that the preceding description relates to a particular preferred embodiment of the invention only and that many modifications are possible within the broad scope of the invention. Some of those modifications are indicated herein, and others will be apparent to a person skilled in the art.

For example, instead of the over-centre linkage 68, it may be possible to cause the required displacement of rod 54 using a simple abutment.

The sweep may be used with any type of sliding door; its application is not limited to barn doors.

We claim:

1. An automatic sweep for a sliding door movable between an open position and a closed position, the sweep comprising:
an elongate seal member adapted to be coupled to a bottom end of the door for movement between a raised position and a lowered position; and,
means for moving the seal member between said raised position and said lowered position, comprising: an elongate operating element that extends generally parallel to and above the seal member and is longitudinally displaceable between first and second positions corresponding respectively to open and closed positions of the door; means coupling said operating element with the seal member and adapted to translate said longitudinal displacement of the operating element into movement of the seal member between said raised and lowered positions, and actuator means that projects laterally of the sweep for co-operation with stationary abutment means adjacent an opening to be closed by the door in use, said actuator means and abutment means co-operating to cause movement of said operating element to its said second position as the door moves to its closed position, moving the seal member to its lowered position and to cause movement of said operating element from said second position to said first position as the door is moved away from its said closed position towards its open position, raising the seal member.

2. A sweep as claimed in claim 1, wherein said operating element moves to its said second position in a direction opposite to the direction in which the door closes, and wherein said coupling means comprises leaf-spring means having a first end connected to said operating element and a second end which is fixed with respect to the element, the leaf-spring means being arranged to exert downward pressure on the seal member as the element is displaced in response to the door reaching said closed position.

3. A sweep as claimed in claim 2, wherein said leaf-spring means comprises three arched spring segments arranged end-to-end and coupled to said seal member at the intersections between said segments.

4. A sweep as claimed in claim 3, wherein the operating element includes a rod having a first end to which said leaf-spring means is coupled and, at a second end of said rod, an over-centre linkage which is movable between an extended configuration corresponding to said first position of the operating element, in which the seal member is in said raised position, and an angled configuration corresponding to said second position of the operating element, when the seal member is in said lowered position, said actuator means and abutment means co-operating to move said over-centre linkage between its extended configuration and its angled configuration as the door moves to and from said closed position.

5. A sweep as claimed in claim 4, wherein said over-centre linkage comprises inner and outer links disposed end-to-end and pivotally coupled together, said inner link being coupled to said rod and said outer link comprising said actuator means and being mounted on a pivot pin, and wherein said outer link is shaped to co-operate with said abutment means, so that the link turns on said pivot pin, causing the linkage to adopt said angled configuration as the door moves to its said closed position, and to adopt said extended configuration as the door moves away from its closed position.

6. A sweep as claimed in claim 4, further comprising spring means biassing said linkage to said angled configuration.

7. A sweep as claimed in claim 1, further comprising a housing adapted to be coupled to a lower marginal portion of a door to which the sweep is attached, the housing slidably receiving said seal member for movement between said raised position and said lowered position, and accommodating, above said seal member, said elongate operating element, said coupling means and said actuator means.

8. A sweep as claimed in claim 7, wherein said housing further defines a track for receiving a guide roller carried by a fixed wall structure with which said sliding door is associated, and arranged to maintain the door parallel to an outer surface of said fixed wall structure as the door moves between said open position and said closed position.

9. An automatic sweep coupled to a sliding door movable between an open position and a closed position with respect to said wall structure, the sweep comprising:
a housing forming a lower marginal portion of the door;
an elongate seal member coupled to said housing for movement between a raised position and a lowered position and said lowered position, comprising: an elongate operating element that extends generally parallel to and above the seal member and is longitudinally displaceable between first and second positions corresponding respectively to open and closed positions of the door; means coupling said operating element with the seal member and adapted to translate said longitudinal displacement of the operating element into movement of the seal member between said raised and lowered positions, and actuator means that projects laterally of the sweep for co-operation with stationary abutment means adjacent an opening in said fixed wall structure, said actuator means and abutment means co-operating to cause movement of said operating element to its said second position as the door moves to its closed position, moving the seal member to its lowered position and to cause movement of said operating element from said second position to said first position as the door is moved away from its said closed position towards its open position, raising the seal member.
